(19) United States
(12) Patent Application Publication
(10) Pub. No.: US 2015/0006223 A1
(43) Pub. Date: Jan. 1, 2015

(54) PURCHASING AND SCHEDULING SERVICES AND PRODUCTS

(71) Applicant: TimeSupply, LLC, Cedar City, UT (US)

(72) Inventors: Jake Daniel Leslie, Washington, UT (US); Jared Michael Westhoff, Leeds, UT (US)

(21) Appl. No.: 14/321,763

(22) Filed: Jul. 1, 2014

Related U.S. Application Data
(60) Provisional application No. 61/841,827, filed on Jul. 1, 2013.
(60) Provisional application No. 61/841,831, filed on Jul. 1, 2013.
(60) Provisional application No. 61/841,836, filed on Jul. 1, 2013.

(51) Int. Cl. G06Q 30/06; G06Q 10/10

(52) U.S. Cl. CPC G06Q 30/0625; G06Q 10/1097; G06Q 30/0633
USPC 705/7.21; 705/26.62

(57) ABSTRACT

An example embodiment includes a method for booking multiple services with multiple providers simultaneously. The method includes receiving a request for available services and service providers and displaying a search results page to the client depicting the available services and service providers. The method also includes receiving a first selection for a first service from a first service provider and adding the first selection to a service cart pending checkout. The method includes receiving a second selection for a second service from a second service provider. The second selection may be added to the service cart pending checkout. The method may include displaying a time and date selection interface and receiving a time and date selection for each of the first and second services. A service checkout interface may be displayed and payment may be received for the first and second selections in the service cart.

### CROSS-REFERENCE TO RELATED APPLICATIONS

This application claims the benefit of and priority to U.S. application Ser. Nos. 61/841,831, 61/841,827, and 61/841,836, which are incorporated herein by reference in their entireties.

### FIELD

Embodiments described herein relate generally to purchasing and scheduling services and products.

### BACKGROUND

Systems in the marketplace enable clients to identify and purchase services that are singular or already grouped into packages with online scheduling applications. These systems are not well suited for handling the selection, scheduling, processing, and payment for service-based organizations. Additionally, the integration between these systems and calendaring applications is problematic.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

### SUMMARY

According to an aspect of an embodiment, a method for booking multiple services with multiple providers simultaneously. The method includes receiving a request for available services and service providers and displaying a search results page to the client depicting the available services and service providers. The method also includes receiving a first selection for a first service from a first service provider and adding the first selection to a service cart pending checkout. The method includes receiving a second selection for a second service from a second service provider. The second selection may be added to the service cart pending checkout. The method may include displaying a time and date selection interface and receiving a time and date selection for each of the first and second services. A service checkout interface may be displayed and payment may be received for the first and second selections in the service cart.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1 depicts an example process for booking multiple services with multiple service providers simultaneously;

FIGS. 2A-2E depict an example process for purchasing services and products simultaneously and for booking multiple services with multiple service providers simultaneously;

FIGS. 3A and 3B depict an example process for automatically placing booked service appointments on client calendars and provider calendars;

FIG. 4 is a flow diagram illustrating a method for booking multiple services with multiple service providers simultaneously;

FIG. 5 is a flow diagram illustrating an example method for purchasing services and products simultaneously;

FIG. 6 is a flow diagram of an example method for automatically placing booked service appointments on client calendars and provider calendars;

FIG. 7 illustrates an example system in which embodiments described herein may be implemented; and

FIG. 8 illustrates an example machine on which embodiments described herein may be implemented.

### DETAILED DESCRIPTION

Embodiments disclosed herein are generally related to a purchasing interface that may interact with one or more calendar systems. For instance, some embodiments described herein relate to methods and systems for booking multiple services with multiple service providers (provider or service providers) simultaneously or substantially simultaneously. As used herein the phrase “substantially simultaneously” refers to an action or operation conducted without material delay and/or at a highest ascertainable rate. An example embodiment includes a method for booking multiple services with multiple providers simultaneously. The method includes receiving a request from a client for available services and service providers and displaying a search results page to the client depicting the available services and service providers. The method also includes receiving a first selection by the client for a first service from a first service provider and adding the first selection to a service cart pending checkout. The method also includes receiving a second selection by the client for a second service from a second service provider. The first service provider and the second service provider may be different entities or in one entity. The second selection may be added to the service cart pending checkout. The method may also include displaying a time and date selection interface to the client and receiving a time and date selection by the client via the time and date selection interface for each of the first and second services. A service checkout interface may be displayed to the client and payment may be received from the client for the first and second selections in the service cart, which may complete a checkout for the first and second selections.

Moreover, some embodiments described herein relate to methods and systems for purchasing services and products simultaneously or substantially simultaneously. In some embodiments, a client may utilize an interface to search for, select, and schedule one or more desired services. After the client selects one or more of the services, but prior to checkout for those services, the client can then add one or more products to the checkout process. Products are added to the cart one at a time from the selected provider service cart or through a larger checkout system in which the products and services may be purchased from different provider entities simultaneously or substantially simultaneously. During the checkout process, a system smartly performs transactions against multiple providers and splits the transactions according to the providers' calendars. Clients then receive a detailed summary of the transactions and details of the transactions. The details may include date, time, venue, and the like. Moreover, the system gives the client the ability to cancel or postpone one or more appointments within a defined amount of time, which may be in accordance with each of the provider's no-show or cancellation policy. Some examples of the defined amount of time may include 24 hours prior to an event, six hours prior to an event, a week prior to an event, or any other suitable defined amount of time which may be set forth or defined by the providers.

For example, an embodiment includes a method for purchasing services and products simultaneously or substantially simultaneously. The method may include receiving a request from a client for available services and service providers. The method may also include displaying a search result to the client depicting the available services and receiving a first selection by the client for a service. The method may also include adding the first selection to a service cart pending checkout and receiving a second request from the client for products or triggering a product recommendation to the client. The method may also include displaying product results to the client depicting products available for selection and receiving a second selection by the client for an available product. The method may also include adding the second selection to the service cart pending checkout, displaying a service checkout interface to the client having both the first and second selections therein, and receiving payment from the client for the first and second selections in the service cart, which completes checkout for the first and second selections.

Additionally, some embodiments described herein relate to methods and systems for automatically placing booked service appointments on client and provider calendars. For instance, a client may utilize a provided interface to search for, select, and schedule one or more desired services, products, or both products and services. After the client selects any desired products and services and finalizes payment through the service cart or arrangements for payments at the service provider's location, a calendar functionality coordinates automatic placement of the booked service onto the calendar of one or more providers and additionally coordinates placement of the booked service onto the calendar of the client. The booked services are automatically and contemporaneously placed upon the provider's calendar and a client's calendar and displayed thereon. Additionally, the client may postpone or cancel an appointment. The system also sends a text, e-mail, or phone call to alert the client prior to the appointment according to a preferred medium. The system stores this information securely in a database and associates it with the client and the provider so it renders to their calendars accordingly and with the integration of web services.

For example, an embodiment includes a method for purchasing services and products simultaneously or substantially simultaneously. The method may include receiving a request from a client for available services and service providers. The method may also include displaying a search result to the client depicting the available services and receiving a first selection by the client for a service. The method may also include adding the first selection to a service cart pending checkout and receiving a second request from the client for products or triggering a product recommendation to the client. The method may also include displaying product results to the client depicting products available for selection; receiving a second selection by the client for an available product and adding the second selection to the service cart pending checkout. The method may also include displaying a service checkout interface to the client having both the first and second selections therein and receiving payment from the client for the first and second selections in the service cart completing checkout for the first and second selections. The method also includes adding a calendar appointment for the service to both a provider calendar for a provider at which the service is booked by the client and contemporaneously adding the calendar appointment to a personal calendar of the client (client calendar).

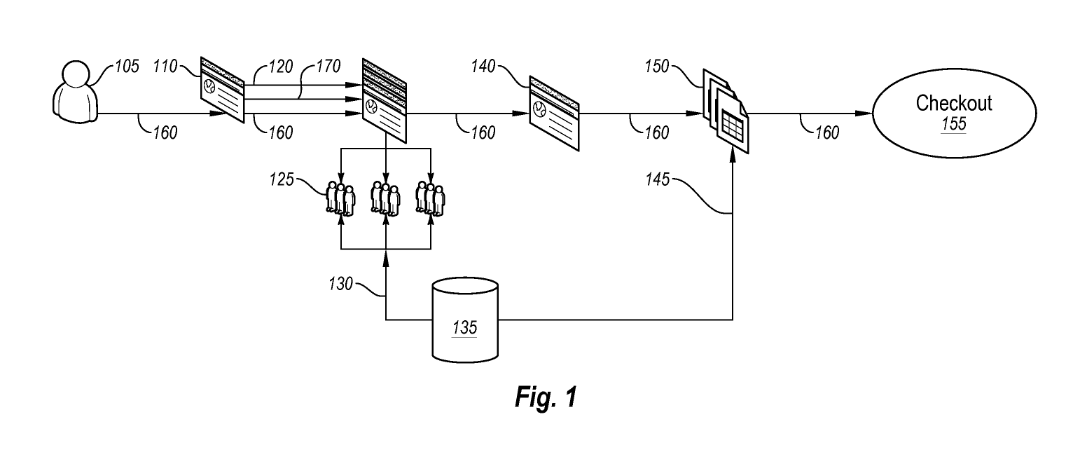

FIG. 1 depicts a process 100 for booking multiple services with multiple service providers 125 simultaneously or substantially simultaneously. The process 100 may be implemented within a host organization (host) that provides cloud computing services to enable one or more operations described herein. For instance, a client 105 of the host may select two or more different services from two or more providers 125, or may select the same or similar services from two or more providers 125, or may select different services from multiple providers 125 by interfacing and interacting with the host or an interface provided to the client 105. The host provides the backend processing to enable such interactions. Additionally or alternatively, the client 105 may select multiple times and dates for a selected bundle of services, the client 105 may schedule the selected bundle of services for a same date and time, or the client 105 may select different dates and times for some subset of services without defining a bundle of services.

For instance, the client 105 may select a shampoo and a haircut to be scheduled at the same date and time or in consecutive time spots. The shampoo and the haircut may be performed by the same provider 125 or by two providers 125. Alternatively, two haircut and shampoos (e.g., a bundle of the haircuts and shampoos) may be performed on the same date and time for two different clients. Alternatively, two haircuts and shampoos may be selected, but the dates and times may be set for a month apart for the same client 105 or for different clients. The shampoo and the haircut may be provided by a single provider 125, such as a salon, or by multiple providers 125, such as independent contractors or employees in a salon.

Regardless of the quantity, type, and scheduled times of the services, all of the services may coordinated and paid for as part of the same checkout session. By enabling the services to be coordinated and paid for in the same checkout session, the process of scheduling may be simplified on behalf of the end user. The host handles the disbursement of funds and scheduling confirmations on behalf of the client 105 and the providers 125 without requiring further involvement of either.

For all providers 125 (e.g., barbers, tax preparers, dog groomers, financial planners, etc.), the process 100 is used by the host as long as the provider is capable of taking orders or accepting appointments for service. In some instances, the providers 125 may also provide products for sale in addition to the services being provided which can be part of the checkout as described elsewhere herein.

The process 100 includes the client 105 who interfaces with the host. The client 105 may visit the service cart and select desired services as depicted by an element 110. Although the services are provided by other providers and/or several providers in the same provider or location, the selection of such services is enabled by the interface provided at the host. In the process 100, a first arrow type 160 is used to depict a standard flow of an example application. A second arrow type 165 is used to depict backend flow of data. Additionally, a third arrow type 170 is used to depict an update on the basis of a decision of the client 105.

At 120, multiple services are selected simultaneously or within the same concurrent service cart session. In response, the service cart shows the multiple providers 125 to the client 105 via the interface provided by the host.

The client 105 selects one of the providers 125 for each of the services chosen. At element 130, the interface of the host is updated with information about the providers 125 that matches the services selected as well as the availability for the services selected according to the schedules of the respective providers 125. For instance, information pertaining to the schedules may be pulled from an interfaced database 135. The database 135 may include a provider database and may include provider times and schedules.

The host also authenticates the process 100. For example, at 140 a check is performed by the host to determine whether the client 105 is already logged or authenticated. If not, then the client 105 is prompted to log in or authenticate before advancing to the interface for selecting timeslots.

At 145, the host calculates and displays the available time slots for each of the providers 125 selected. If the client 105 changes the date for the selected services, then the host refreshes the display with an updated list of available time slots for each provider 125 on the new date selected by the client 105.

At 150, the host calculates the available dates and time slots for each date. The host compares the available timeslots against each of the time slots selected by the client 105 for each of the providers 125 selected. At 155, the client 105 has chosen the time and the date for the services desired according to the calculated availability for such services and the specified providers 125. The client 105 may accordingly proceed to checkout. At checkout payment or deposits can be transferred to confirm and secure the chosen times and dates for the services.

The process of FIG. 1 can be initiated by a client 105 entering a booking process of the service cart through a “Book Now” button. The Book Now button can be placed on third party website or can be placed on advertisements that are accessed by the client 105 on a webpage such as social media postings, personal pages, business pages, search results pages, or other internet ads. The booking process may be integrated or incorporated into one or more of the sources via a code snippet which may enable placement of the “Book Now” button. Additionally or alternatively, a webpage may be generated for the entity that can be searched via a backend home page or the internet that may be a standalone website or landing page of a service provider that allows the client 105 to initiate the booking process.

Based at least partially on the source through which the client 105 enters the booking process, the booking process can be narrowed. For example, the booking process can be narrowed to a specific service provider, a specific service linked to a set of service providers, a specific service linked to more than one provider, or any combination thereof

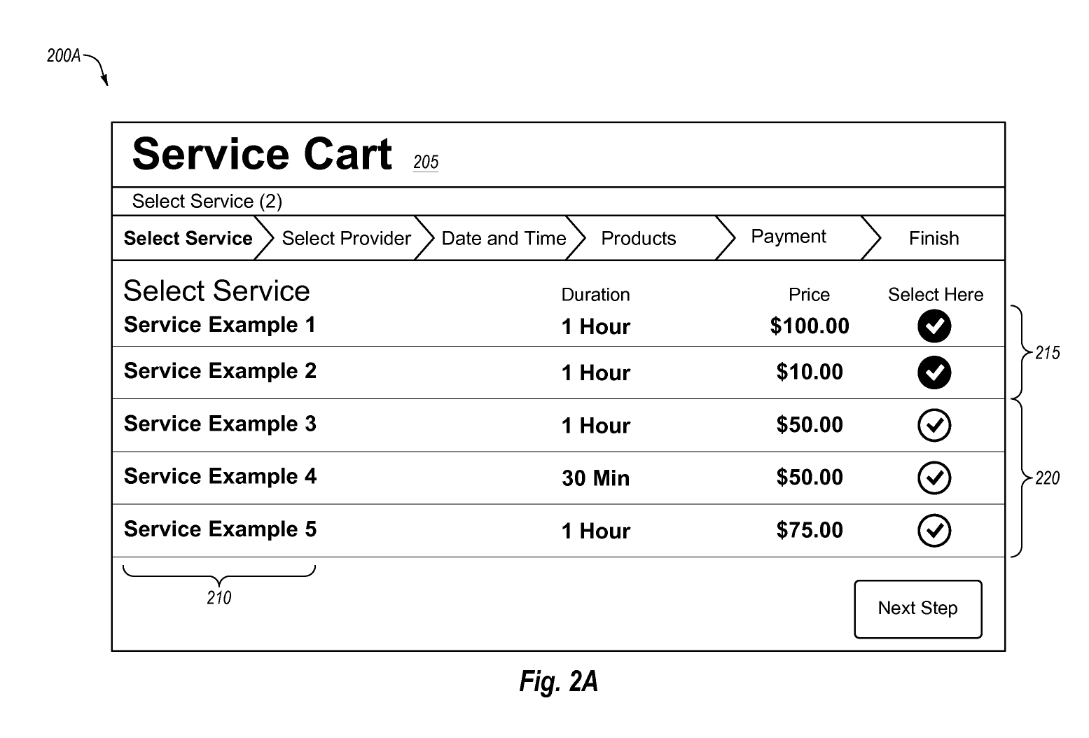

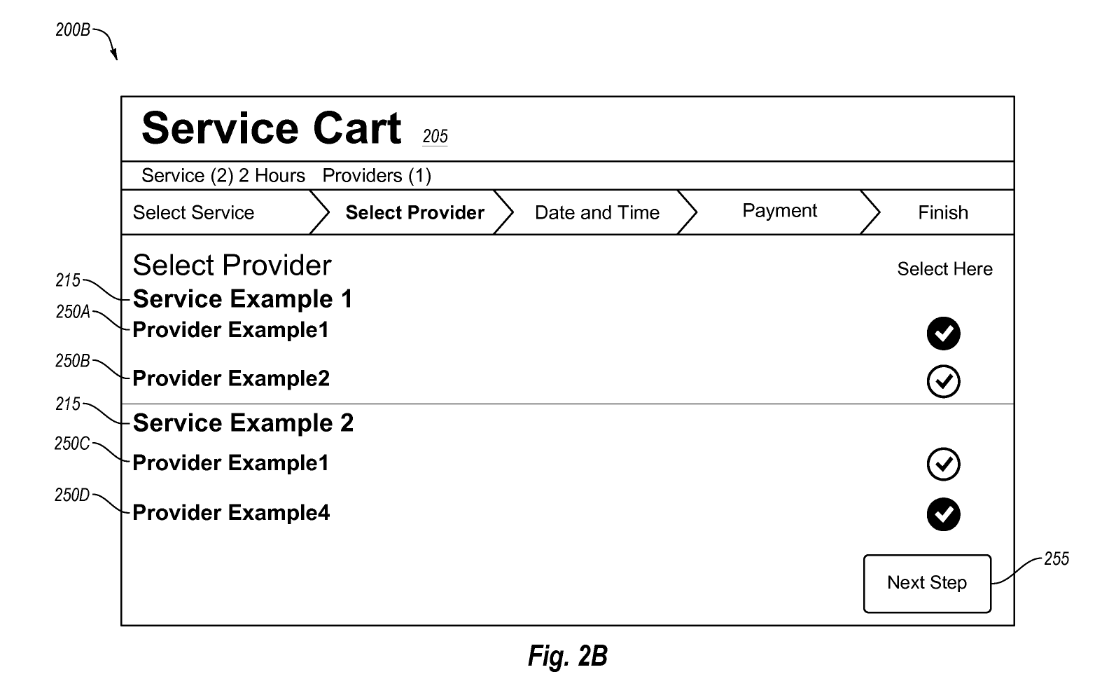

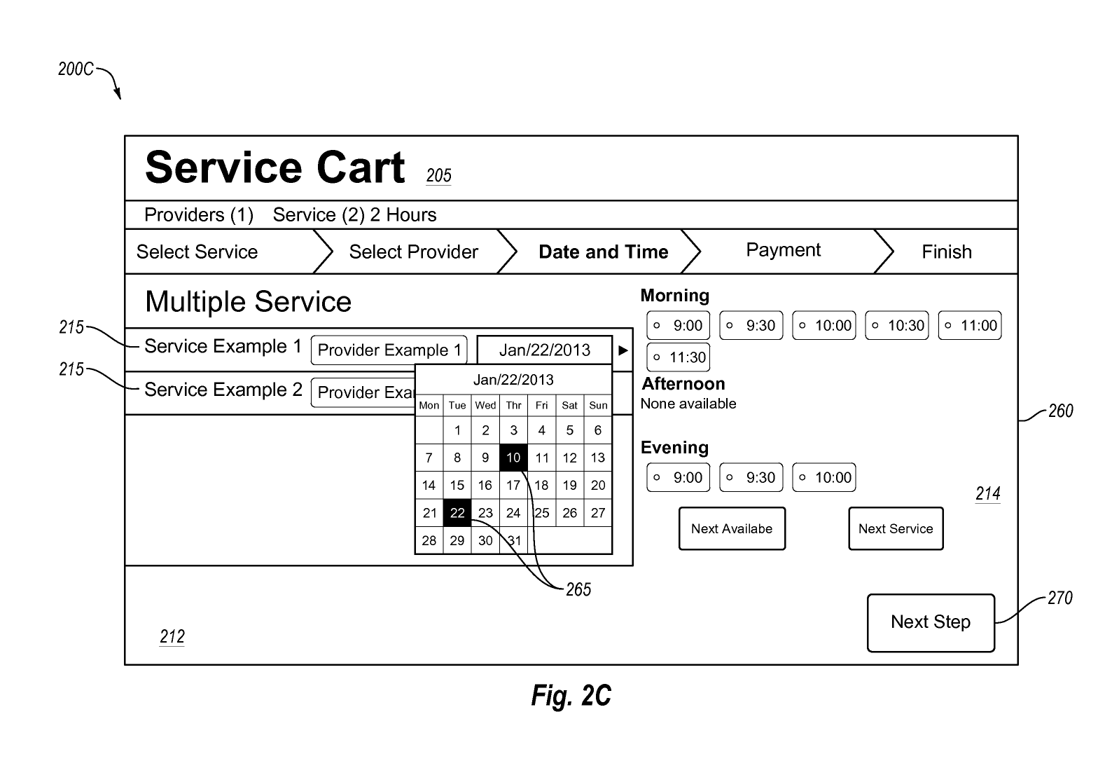

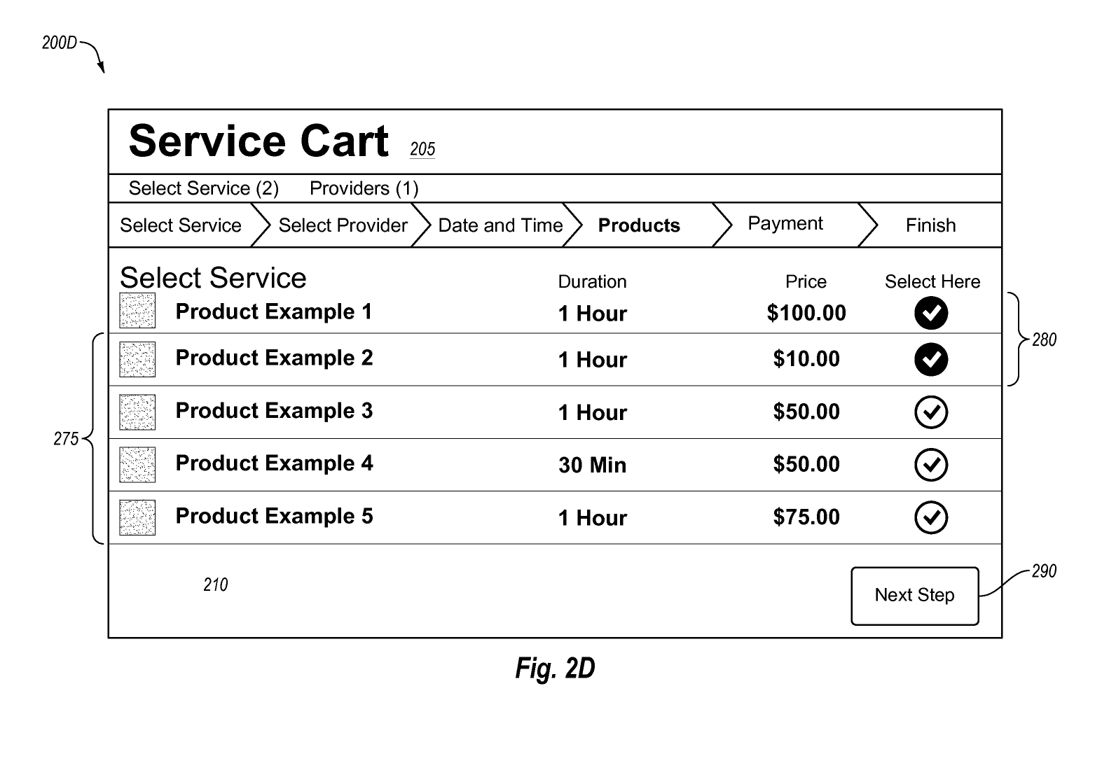

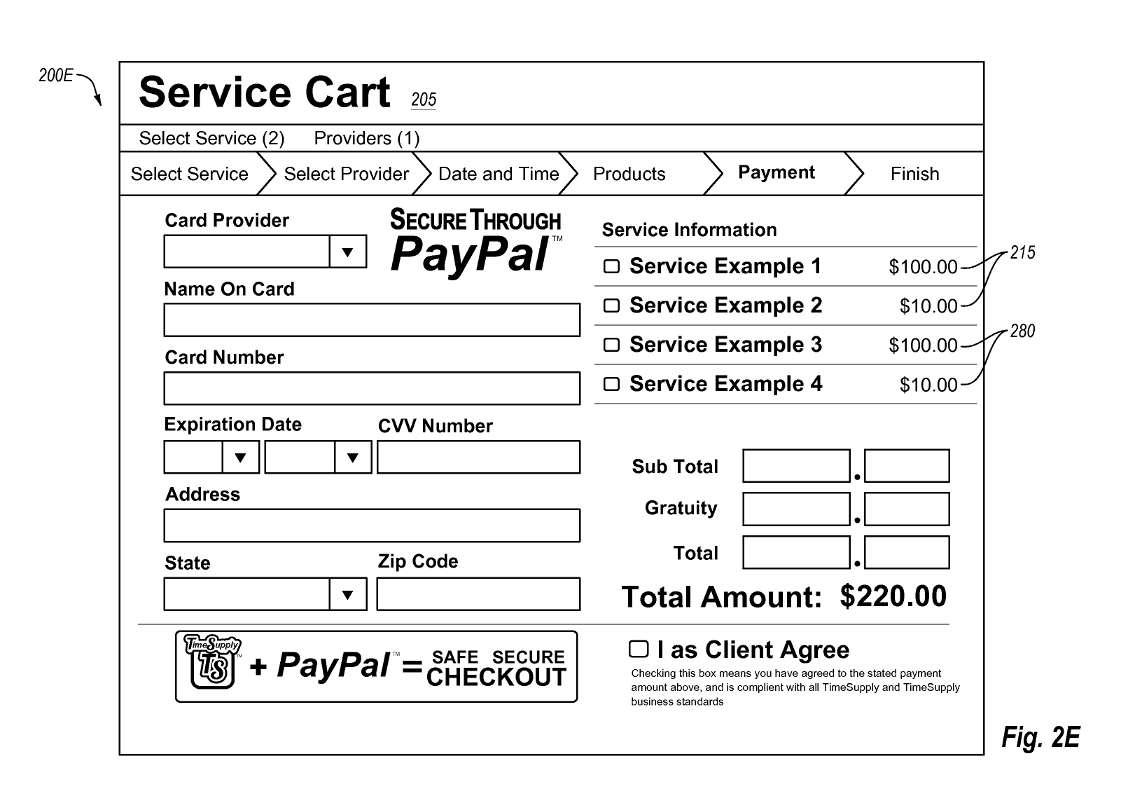

FIGS. 2A-2E illustrate a series of screenshots 200A-200E that may be included in a process for purchasing services and products and/or in booking services with multiple providers. In the process, purchasing and booking may occur simultaneously or substantially simultaneously. One or more of the steps in the process may be performed by a host system as described elsewhere herein.

The process is primarily performed through interfacing with a service cart 205. The service cart 205 may include or interface with one or more modules and provide on a front end the screenshots 200A-200E to a client. In the process, clients (e.g., the client 105 of FIG. 1) may provide input effective to purchase products using the service cart 205 during a same transactional instance with booking services. Additionally or alternatively, multiple services may be booked during a same transactional instance using the service cart 205. The process includes a provision of the service cart 205 as a module that manages web-based business transactions between one or more providers (e.g., the providers 125 of FIG. 1) and the client.

In general, the client may be prompted to select one or more service options offered by one or more providers. If multiple services are selected, then a database (e.g., the database 135 of FIG. 1) generates a list of the providers that offer the selected services. The client is presented with a list of the service providers that perform the requested services. The client is prompted to select one service provider or different providers for the services which may have been previously selected. After the service providers have been selected, the client is prompted to choose for the selected service, dates and times during which the service providers are available. The client selects the preferred available service date and time from the interface calendar, which is generated by the service providers' schedules. In some embodiments, first a date is selected. In response, the database generates the service providers' available times for that specific service. The times shown are calculated by service duration and availability in the database. In the situation of multiple selected services, the client selects the date and time for the first service then performs the same process for each of the remaining services, but in the same simultaneous process.

After the client is finished with selecting the services desired, but prior to checkout for those services, the client can then add one or more products to the checkout process. The products are added to the cart one at a time from the selected provider service cart or through a larger checkout system in which the products and services may be purchased from different provider entities simultaneously. Some additional details of the process such as adding additional products for purchase with the previously selected services is described in additional detail in FIGS. 2A-2E.

FIG. 2A depicts a first screenshot 200A, which may be a first step in the process displayed in the screenshots 200A-200E. In the embodiment of FIG. 2A, one or more available services 210 may be provided in the service cart 205. A client may select one or more of the available services 210 in the service cart 205. For example, the client may select selected services 215 and not select non-selected services 220. The selected services 215 and the non-selected services 220 may be provided to a system for processing. The services 210 may be presented at once in the first screenshot 200A. This means each of the providers do not have to do several variations of service bundles and allows the client to book multiple services at a single time or separate each service into an individual time.

In the first screenshot 200A, the services of multiple providers are displayed. The depicted embodiment may be presented in circumstances in which a third party or neutral party is providing a site for commerce and competition between the service providers. In some embodiments, the service cart 205 may be provided by a single entity that may provide a single service. In these and other embodiments, the input provided by the client may include the time and date (e.g., if one service is provided) or the time and date along with a selection from the provided services. In particular, the service cart 205 may not provide information or enable selection of service provided by competitors or other service providers.

An example of a service may include a class/seminar that includes a limited number of spots. The service provider can put the number of clients that can be accommodated. Additionally one or more resources tied to providing the service may be indicated. For example, a seminar can be a service that can seat 200 people. The service provider can limit booking to 200 via the service cart 205.

Another example service may include a service in which a common resource is shared by multiple service providers. The system implementing the service cart 205 may track the allocation of the resources between the multiple resources to ensure against double booking the resource. For example, service providers may include three therapists that share two therapy rooms. Once both of the rooms are booked for a particular time, the system may no longer list the service by the therapist during that time due to unavailability of the rooms. Some additional examples may include tools, equipment, inventory, etc. that may be shared by service providers.

FIG. 2B depicts a second screenshot 200B that may be a second step in the process. The second screenshot 200B again includes the service cart 205. In the second screenshot 200B, for the previously selected services 215, the client is presented with an interface through which one or more providers 250A-250D (generally, provider 250 or providers 250) of the selected services 215 may be chosen. For example, if a haircut is selected on the first screenshot 200A of FIG. 2A, then at the provider selection interface in the second screenshot 200B the client is presented with available providers 250 for the desired haircut. The client provides input effective to select one or more of the providers 250 for each of the selected services 215. The selections are communicated back to the system by clicking a “Next Step” button 255 on the display interface of the second screenshot 200B.

FIG. 2C depicts a third screenshot 200C which may be a third step in the process. In the third screenshot 200C, the client is presented with a date and time selection interface 260 for each of the selected services 215. Available selections (e.g., 265) are limited according to the selected service 215 and the provider 250 selected by the client. For example, in the depicted embodiment, for the service example 1, there are no “Afternoon” sessions available as depicted for the date chosen, but there are morning and evening appointments still available. The client provides input effective to select a time and date selection for the first service selected 215 and then for the second service selected 215, and then clicks a “Next Step” button 270 to communicate the selected date and time selections to the system for processing.

In the third screenshot 200C a date may be selected on a left side 212 and a time on a right side 214 of the date and time selection interface 260. In other embodiments, the date and time selection interface 260 may be organized differently.

Additionally or alternatively, the client may provide input effective to select the “Next Step” button 270 without selecting a date and time. In response, the system automatically identifies, displays, and selects the next available appointment for one or more of the selected services 215 and the provider 250. The client may then provide input effective to select the “Next Step” button 270 to accept or may provide additional input to make further changes as desired.

In the third screenshot 200C, the services are booked first followed by a selection of a date and time. In some embodiments, the times and dates that are available for the client may be included in an initial search (e.g., as described in the first screenshot 200A). In these and other embodiments, the services presented in the first screenshot 200A may be filtered according to the time included in the initial search. Additionally, in these and other embodiments, the third screenshot 200C may enable a confirmation of the time and date for selected services.

FIG. 2D depicts a fourth screenshot 200D that may be a fourth step in the above process. The fourth screenshot 200D display what may occur for a client wishing to select and purchase products simultaneously or substantially simultaneously with the selected services 215 during the same service cart session. For instance, after the client selects the selected services 215 and provides additional information (e.g., date and time and the provider 250), the client may be presented with a service cart display having products 275 available for purchase. The products 275 may be selected by the client, suggested by the system due to their relatedness to the selected services 215, due to sponsors requesting the products 275 to be suggested, due to the products 275 being involved in one or more of the selected services 215, or due to other configurable criteria. For example, in the fourth screenshot 200D, there are five products 275 examples and the client has selected two of selected products 280 of the five for purchase simultaneously with purchase of the selected services 215. The client may then provide input effective to select a “Next Step” button 290, which may communicate the selected products and information pertaining thereto to the system.

In some embodiments, a service provider may select to not sell products associated with a particular service. In these embodiments, products may not be displayed to the client in the fourth screenshot 200D and/or a notice may be presented to the client indicating that the service provider does not offer products along. The notice may be presented with recommendations of other sources of products.

Additionally or alternatively, payment can also be split. For instance, the payment can be split between one or more service bookings at multiple locations or times. For example, the client can book the same hair appointment in reoccurring fashion for 6 months. Additionally, the payment type can change per service or per service provider according to the payment settings the client chooses.

Additionally, in some embodiments, payment may not be provided via the service cart 205 (e.g., if the client wishes to pay upon rendering of services). In these and other embodiments, service providers can set up a default “No Show Policy.” The No Show Policy may include a collection for an appointment that the client neglects to show. Furthermore, the No Show Policy may set up overrides per specific service. The override can be for bundle service or service offered at a discount so that a purchase can be made final without a grace period.

FIG. 2E depicts a fifth screenshot 200E that may be a fifth step in the above process. In the fifth screenshot 200E, the service cart 205 displays a purchase services and products interface through which the client may finalize payment for the selected services 215 and the selected products 280. The selected services 215 and the selected products 280 may be paid for using this service cart interface or if the service and product providers permit, then the client may be able to select “Pay on Arrival” instead of the “pay now” option.

In the embodiment depicted in FIG. 2E, payment may be submitted through a secure system (e.g., PAYPAL®) portal through which the service cart 205 is linked through a specially configured application programming interface (API). Other interfaces in support of payment may be made through credit card processors or other payment providers that support an API-based connection with third party applications.

In the depicted screenshots 200A-200E, the services are booked first followed by products, if desired by the client. In some embodiments, products are selected first followed by one or more services. In these and other embodiments in which the products are selected first, one or more services may be recommended or suggested rather than the one or more services being recommended as discussed above.

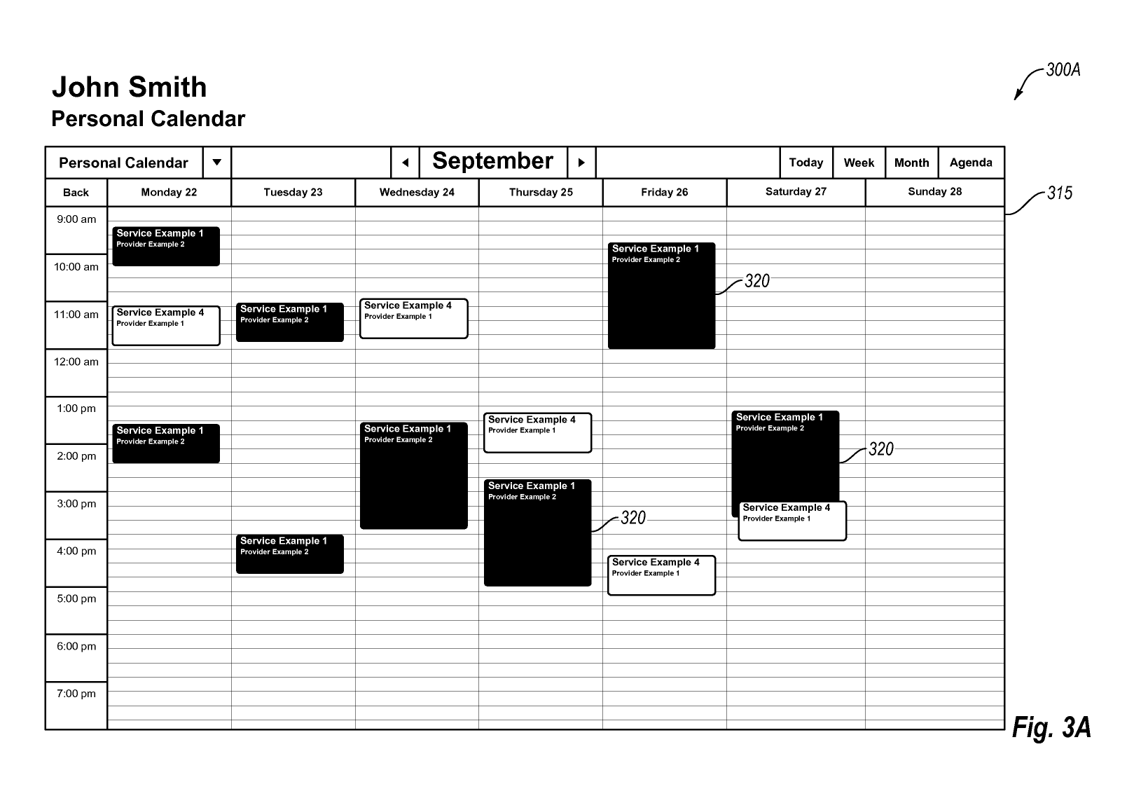

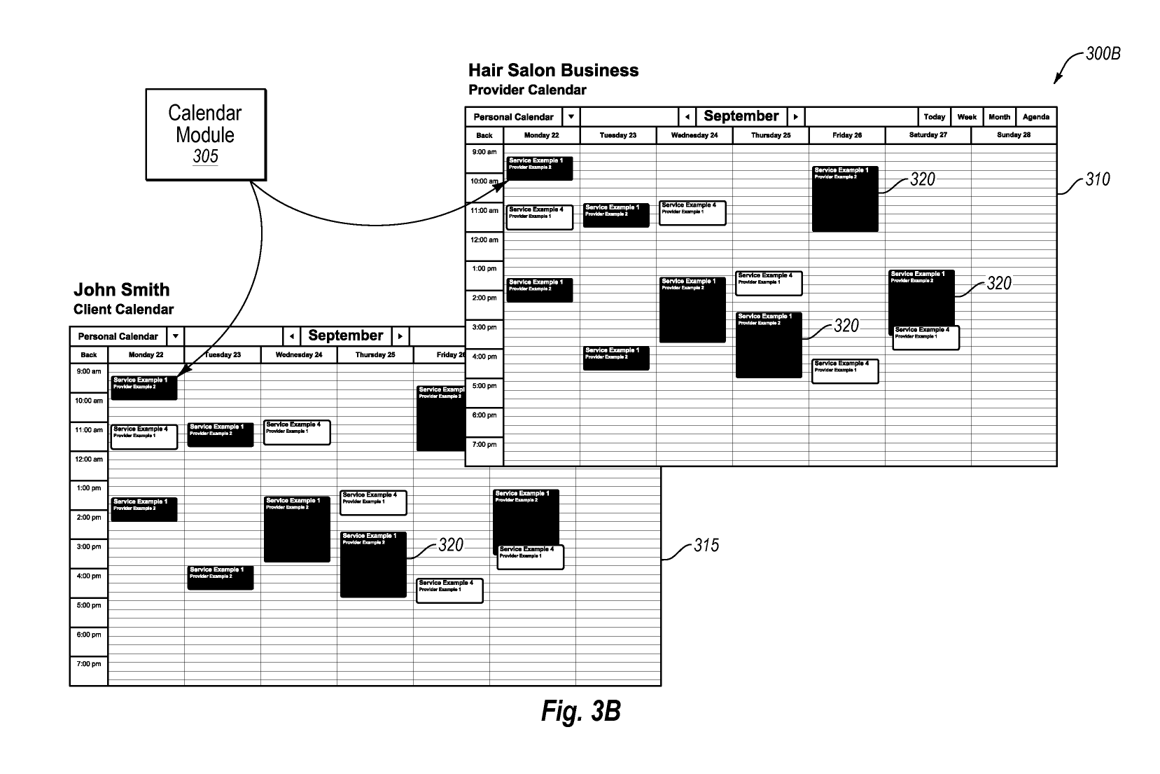

FIGS. 3A and 3B depict screenshots 300A and 300B that illustrate one or more steps in a process for automatically placing booked service appointments on a client calendar and a provider calendar. In some embodiments, a calendar module 305 places the appointments onto a client calendar 315 and a provider calendar 310 simultaneously or substantially simultaneously in response to scheduling services and/or payments for services. As described with reference to FIGS. 2A-2E, clients (e.g., the client 105) can purchase services and optionally products via a service cart (e.g., the service cart 205) in the same instance or checkout process. After the client is finished with selecting services and finalizing payment the calendar module 305, which provides calendar functionality, places the newly booked appointments for the services onto the client calendar 315 and the provider calendar 310 of a provider of such services.

The calendars (e.g., 310 and 315, collectively calendars 310/315) each individually reflect the newly scheduled appointment as well as previously scheduled appointments and rescheduled appointments. Some embodiments provide checks and balances regarding scheduling. For example, one or both of the calendars 310/315 may indicate whether the provider is available at the selected date and time, whether a chosen service accounts for multiple appointments, and other conditions/rules specified by providers. If there are no conflicting rules, an appointment is scheduled successfully on the calendars 310/315, which ensures that no appointments are scheduled that conflict. Providers can then accept additional appointments from other clients. Similarly, clients can add additional events or appointments to the client calendar 315.

FIG. 3A depicts the client calendar 315 of a client “John Smith” who books multiple appointments 320. The client calendar 315 is a calendar interface. The appointments 320 are reflected on the client calendar 315. The client may place other appointments 320 on the client calendar 315 as well.

In some embodiments, the client calendar 315 is hosted by a host organization that also provides the service cart described above. In other embodiments, the client calendar 315 is provided by a third party that provides scheduling services and the client calendar 315. In these and other embodiments, the host may push or otherwise place the appointments 320 to the client calendar 315 after the client books one or more services.

FIG. 3B depicts the client calendar 315 for John Smith and the provider calendar 310. Specifically, the provider associated with the provider calendar is “Hair Salon Business.” The calendar module 305 pushes or otherwise places the appointments 320 for booked services automatically and simultaneously or substantially simultaneously onto both the client calendar 315 and the provider calendar 310 for the provider after the services are booked by the client.

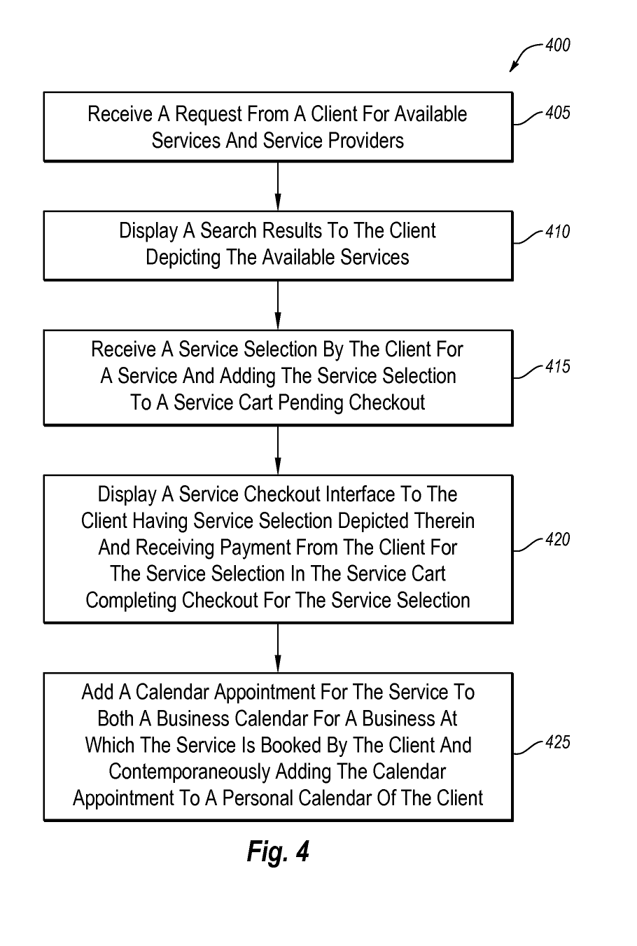

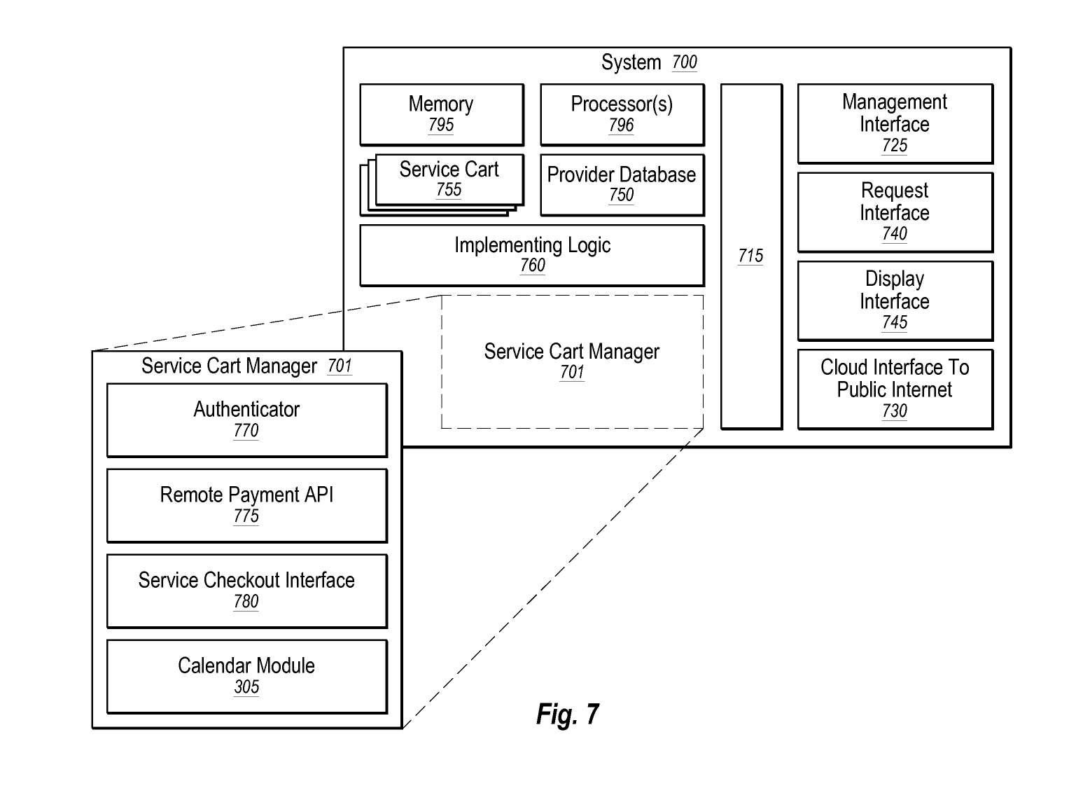

FIG. 4 is a flow diagram illustrating a method 400 for booking multiple services with multiple providers simultaneously or substantially simultaneously. The method 400 may be performed by processing logic that may include hardware and/or software. The hardware may include circuitry, dedicated logic, programmable logic, microcode, and the like. The software may include instructions run on a processing device to perform various operations such as receiving, generating, populating, storing, injecting, recording, marking, restricting, and transmitting information and data in pursuance of booking multiple services with multiple providers simultaneously through a cloud computing service provider. In some embodiments, the method 400 is performed by a hardware-based system, such as system 700 as discussed with reference to FIG. 7. Some of the blocks and/or operations listed below are optional in accordance with one or more embodiments. The numbering of the blocks presented is for the sake of clarity and may not necessarily prescribe an order of operations in which the blocks occur. Although illustrated as discrete blocks, various blocks may be divided into additional blocks, combined into fewer blocks, or eliminated, depending on the desired implementation. The method 400 begins at block 405. At block 405, a request may be received from a client for available services and service providers. At block 410, a search results page may be displayed to the client depicting the available services and service providers. At block 415, a first selection may be by the client for a first service from a first service provider. The first selection may be added to a service cart pending checkout. At block 420, a second selection may be by the client for a second service from a second service provider. The second selection may be added to the service cart pending checkout. At block 425, a time and date selection interface may be displayed to the client. A time and date selection may be by the client via the time and date selection interface for each of the first and second services. At block 430, a service checkout interface may be displayed to the client. Payment may be received from the client for the first and second selections in the service cart. The payment may complete checkout for the first and second selections.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments. For example, the method 400 may include authenticating the client with the host organization as a known client prior to displaying a time and date selection interface to the client.

Additionally or alternatively, the method 400 may include receiving a request from the client for available services and service providers. The request may include receiving search parameters from the client for the available services and service providers. In some embodiments, the search parameters are geographically constrained according to default search parameters, determined on behalf of the client, or based on explicit search parameters provided by the client. Additionally or alternatively, the search parameters are time constrained according to default search parameters determined on behalf of the client or based on explicit search parameters provided by the client. In some embodiments of the method 400, receiving the request from the client for available services and service providers includes receiving the request via a search engine service provider external to the host organization or receiving the request via a search interface provided by a host organization.

In some embodiments, the host organization, which may have a processor and a memory, operates as a cloud computing service provider that is accessible to a client device utilized by the client via a public network such as the Internet. In these and other embodiments, the service providers may operate as distinct entities separate from the host organization and the available products are provided by one or more entities distinct from the host organization.

In accordance with some embodiments, there is a non-transitory computer-readable storage medium having instructions stored thereon that, when executed by a processor in a host organization, the instructions cause the host organization to perform or control performance of one or more of the operations of the method 400.

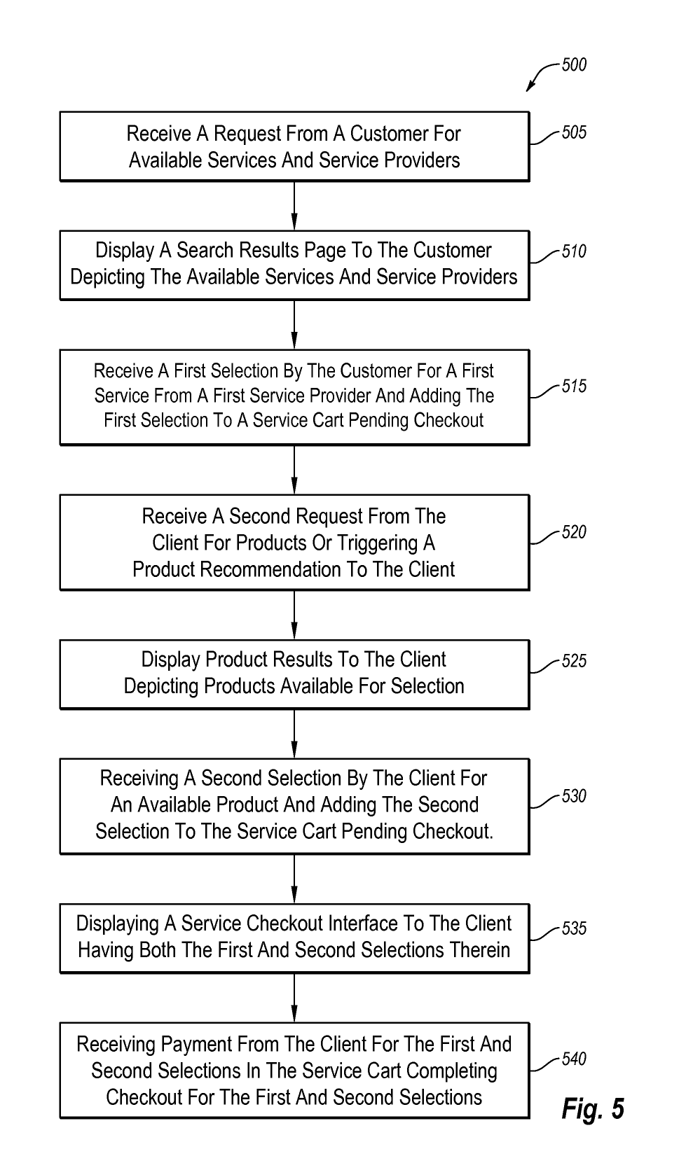

FIG. 5 is a flow diagram of an example method 500 for purchasing services and products simultaneously or substantially simultaneously, in accordance with at least one embodiment described herein. The method 500 may be performed by processing logic that may include hardware and/or software. The hardware may include circuitry, dedicated logic, programmable logic, microcode, and the like. The software may include instructions run on a processing device to perform various operations such receiving, generating, populating, storing, injecting, recording, marking, restricting, and transmitting information and data in pursuance of booking multiple services with multiple providers simultaneously through a cloud computing service provider. In some embodiments, the method 500 is performed by a hardware-based system, such as the system 700 as discussed with reference to FIG. 7. Some of the blocks and/or operations listed below are optional in accordance with one or more embodiments. The numbering of the blocks presented is for the sake of clarity and may not necessarily prescribe an order of operations in which the blocks occur. Although illustrated as discrete blocks, various blocks may be divided into additional blocks, combined into fewer blocks, or eliminated, depending on the desired implementation.

The method 500 begins at block 505. At block 505, a request may be received from a client for one or more available services and service providers. At block 510, a search results page may be displayed to the client. The search results page may depict the available services and service providers. At block 515, a first selection may be received. The first selection may be by the client for a first service from a first service provider. The first selection may be added to a service cart pending checkout. At block 520, a second request may be received. The second request may be from the client for one or more products or triggering a product recommendation to the client. At block 525, product results may be displayed to the client. The product results depict products available for selection. At block 530, a second selection may be received. The second selection may be by the client for an available product. The second selection may be added to the service cart pending checkout. At block 535, a service checkout interface may be displayed to the client. The service checkout interface may include the first and second selections. At block 540, payment may be received from the client for the first and second selections in the service cart. Receiving payment may complete checkout for the first and second selections.

In some embodiments, the method 500 may include displaying to the client via the service cart which providers are available for first service selected. Additionally, the method may include receiving a desired provider selection by the client for the service and displaying a time and date selection interface to the client, which may be specific to the service. The method 500 may further include receiving a time and date selection by the client via the time and date selection interface for the service.

Additionally or alternatively, the method 500 may include adding more than one service to the service cart simultaneously or substantially simultaneously with one or more products or adding more than one product to the service cart simultaneously or substantially simultaneously with one or more services. In some embodiments, a product available from a service provider for the service is selected by the client or a product available from a provider different than the service provider for the service is selected by the client.

In some embodiments the method 500 may include authenticating the client with the host organization as a known client prior to accepting payment from the client for the products and services. Additionally or alternatively, the method 500 may include presenting a pay upon arrival option to the client in lieu of making final payment through the service cart for the first and second selections. In some embodiments, an API is established between the service cart and a third party payments processor to receive payment from the client.

In some embodiments of the method 500 a product recommendation engine automatically presents products available for purchase simultaneously or substantially simultaneously with the selected service. Additionally or alternatively, the recommendation engine presents products available from the service provider selected for pickup or use at the service provider's location when the service is scheduled. Additionally or alternatively, the recommendation engine presents products available from a third party different from the service provider selected; and in which the products are available for shipment and arrival at a location specified by the client prior to the service scheduled with the service provider. Additionally or alternatively, the recommendation engine presents products to the client according to one or more of: paid advertising; products that are capable of use during the service selected; products available from the service provider selected; and products identified responsive to search parameters specified by the client prior to final payment for the services selected.

In some embodiments a host organization, which may have a processor and a memory, operates as a cloud computing service provider that is accessible to a client device utilized by the client via a public network such as the Internet. In these and other embodiments, the service providers may operate as distinct entities separate from the host organization and the available products are provided by one or more entities distinct from the host organization.

In accordance with some embodiments, there is a non-transitory computer-readable storage medium having instructions stored thereon that, when executed by a processor in a host organization, the instructions cause the host organization to perform or control performance of one or more of the operations of the method 500.

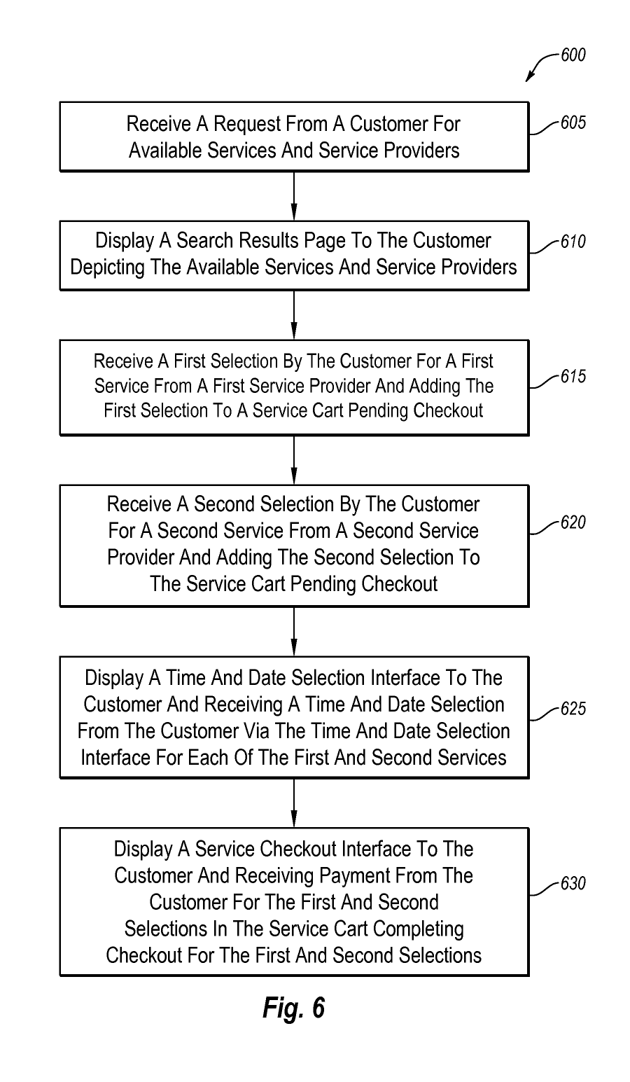

FIG. 6 is a flow diagram illustrating a method 600 for purchasing services and products simultaneously or substantially simultaneously. The method 600 may be performed by processing logic that may include hardware and/or software. The hardware may include circuitry, dedicated logic, programmable logic, microcode, and the like. The software may include instructions run on a processing device to perform various operations such as receiving, generating, populating, storing, injecting, recording, marking, restricting, and transmitting information and data in pursuance of booking multiple services with multiple providers simultaneously through a cloud computing service provider. In some embodiments, the method 500 is performed by a hardware-based system, such as the system 700 as discussed with reference to FIG. 7. Some of the blocks and/or operations listed below are optional in accordance with one or more embodiments. The numbering of the blocks presented is for the sake of clarity and may not necessarily prescribe an order of operations in which the blocks occur. Although illustrated as discrete blocks, various blocks may be divided into additional blocks, combined into fewer blocks, or eliminated, depending on the desired implementation.

The method 600 begins at block 605. At block 605, a request may be received from a client for available services and service providers. At block 610, search results may be displayed to the client depicting the available services. At block 615, a service selection may be received. The service selection may be by the client for a service. The service selection may be added to a service cart pending checkout.

At block 620, a service checkout interface may be displayed to the client. The service checkout interface may include the service selection. Payment may be received from the client for the service selection in the service cart, which may complete checkout for the service selection. At block 625, a calendar appointment may be added for the service to both a provider calendar of a provider and contemporaneously to a client calendar of the client. In some embodiments, the client calendar is hosted by a host organization on behalf of the client. Additionally or alternatively, the client calendar is hosted by a third party.

In some embodiments of the method 600, the calendar appointment is added to the client calendar of the client by the host organization via a third party API for calendar appointments subjected to client authentication at the third party. Additionally or alternatively, in some embodiments, the client selects products for purchase in addition to the service booked and the appointment on the client calendar specifies the product purchased contemporaneously with the services booked.

In accordance with some embodiments, there is a non-transitory computer-readable storage medium having instructions stored thereon that, when executed by a processor in a host organization, the instructions cause the host organization to perform or control performance of one or more of the operations of the method 600.

FIG. 7 illustrates an example system 700 that may implement one or more embodiments described herein. For example, the system 700 may be configured to implement one or more of the methods 400, 500, and 600. Additionally, the system 700 may be configured to provide to a client one or more of the screenshots 200A-200E and 300A and 300B and receive input from the client.

In some embodiments, the system 700 includes a memory 795 and one or more processors 796. The memory 795 may store instructions to be executed and the processors 796 may execute such instructions. The processors 796 may also implement or execute implementing logic 760, which may include logic to implement the methodologies (e.g., 400, 500, 600) discussed herein. The system 700 includes one or more communication buses 715 to transfer transactions, instructions, requests, and data within the system 700 among a plurality of peripheral devices communicably interfaced with one or more communication buses 715. The system 700 includes a management interface 725. The management interface 725 may be configured to receive requests, return responses, and otherwise interface with network elements located separately from the system 700 such that the system 700 may be managed, for instance, by administrators of a host for the system 700.

The system 700 further includes cloud interface to public internet 730 to communicate from the system 700 to clients, for instance, via a public internet. The system 700 further includes a provider database 750 that may have service providers, their services, and dates/times of availability listed as well as other pertinent information. The system 700 further includes a request interface 740 to receive requests from clients and a display interface 745 to display responses or other results to the clients.

The system 700 may further include one or more service carts 755 for clients of the system 700. The provider database 750 and the service carts 755 may be stored upon a hard drive, the memory 795 persistent data store, a database, or other storage location within the system 700. The system 700 may also include a service cart manager 701 which includes an authenticator 770, a remote payment API 775, a calendar module 705, and a service checkout interface 780. The service cart manager 701 may be distinct within the system 700. The service cart manager 701 may be installed and configured in a compatible system 700 as is depicted by FIG. 7, or provided separately so as to operate in conjunction with appropriate implementing logic 760 or other software.

The system 700 may include one or more of the request interface 740; the display interface 745; the service cart manager 701; and the service checkout interface 780. The request interface 740 may be configured to receive a request from a client for available services and service providers; to further receive a first selection by the client for a service; to further receive a second request from the client for products or triggering a product recommendation to the client; and to further receive a second selection by the client for an available product. The display interface 745 may be configured to display a search results page to the client depicting the available services and service providers and to further display the product results to the client depicting products available for selection. The service cart manager 701 may be configured to add the first selection to a service cart pending checkout; to receive payment from the client for the first and second selections in the service cart completing checkout for the first and second selections; and to further add the second selection to the service cart pending checkout. The service checkout interface 780 may be configured to display the service cart and pending checkout selections to the client.

The system 700 further includes the authenticator 770 to authenticate the client with the system 700 as a known client prior to displaying the time and date selection interface (e.g., via the display interface 745) to the client.

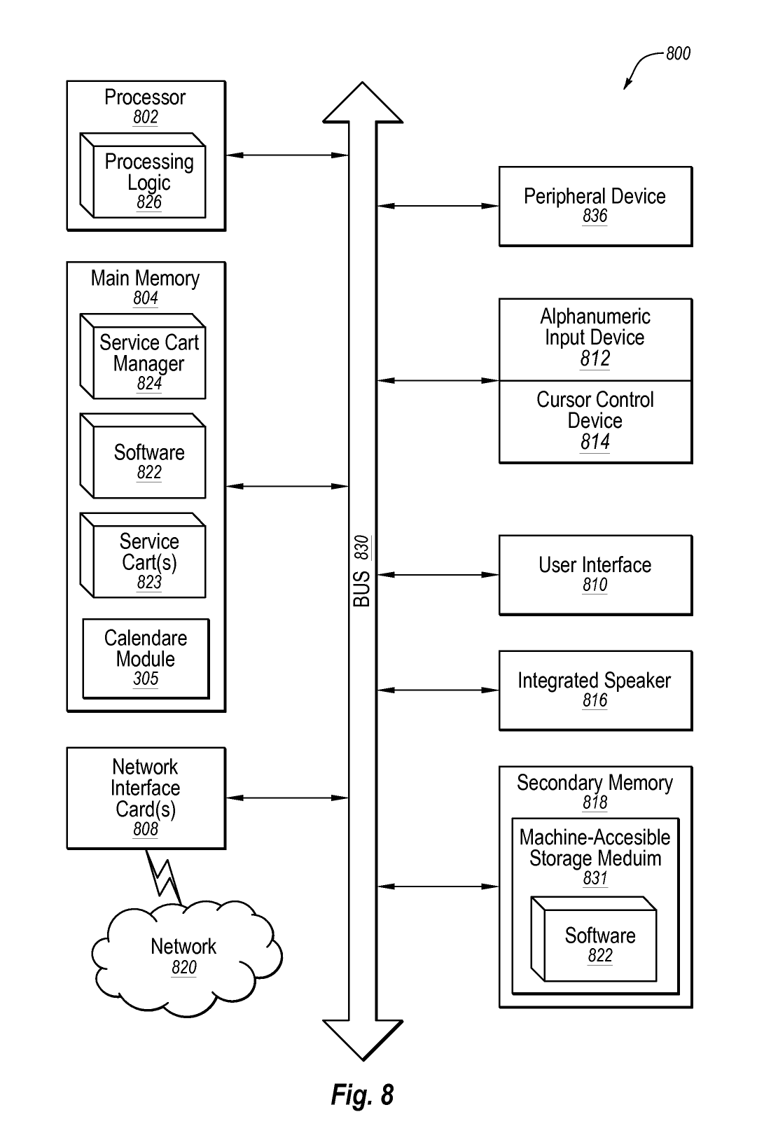

FIG. 8 illustrates an example machine 800 such as a computing device, in accordance with at least one embodiment. Within the machine 800 a set of instructions for causing the machine 800 to perform any one or more of the methodologies (e.g., 400, 500, and 600) discussed herein. In some embodiments, the machine 800 may be connected, networked, interfaced, etc. with other machines in a Local Area Network (LAN), a Wide Area Network, an intranet, an extranet, or the Internet. The machine 800 may operate in the capacity of a server or a client machine in a client-server network environment, or as a peer machine in a peer-to-peer (or distributed) network environment. Some embodiments of the machine 800 may be in the form of a personal computer (PC), a tablet PC, a set-top box (STB), a Personal Digital Assistant (PDA), a cellular telephone, a web appliance, a server, a network router, switch or bridge, computing system, or any machine 800 capable of executing a set of instructions (sequential or otherwise) that specify actions to be taken by that machine 800. Further, while only a single machine 800 is illustrated, the term “machine” shall also be taken to include any collection of machines (e.g., computers) that individually or jointly execute a set (or multiple sets) of instructions to perform any one or more of the methodologies discussed herein.

The machine 800 includes a processor 802, a main memory 804 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 818 (e.g., a persistent storage device including hard disk drives and persistent database implementations), which communicate with each other via a bus 830. The main memory 804 includes information and instructions and software program components necessary for performing and executing the functions with respect to the various embodiments of the methods and systems for booking multiple services with multiple providers simultaneously as described herein. A service cart manager 824 implements the functionality necessary to hold service selections and process service payments on behalf of clients. Service carts 823 on behalf of the clients are stored within the main memory 804 according to one embodiment. The main memory 804 and its sub-elements (e.g., 823 and 824) are operable in conjunction with processing logic 826 and/or software 822 and the processor 802 to perform the methodologies discussed herein.

The processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processor 802 may also be one or more special-purpose processing devices such as an application-specific integrated circuit (ASIC), a field-programmable gate array (FPGA), a digital signal processor (DSP), network processor, or the like. The processor 802 is configured to execute the processing logic 826 for performing the operations and functionality which is discussed herein.

The machine 800 may further include one or more network interface cards 808 to communicatively interface the machine 800 with a public internet through which cloud computing services may be provided to providers and end clients. The machine 800 also may include a user interface 810 (such as a video display unit, a liquid crystal display (LCD), or a cathode ray tube (CRT)), an alphanumeric input device 812 (e.g., a keyboard), a cursor control device 814 (e.g., a mouse), and a signal generation device 816 (e.g., an integrated speaker). The machine 800 may further include a peripheral device 836 (e.g., wireless or wired communication devices, memory devices, storage devices, audio processing devices, video processing devices, etc.).

The secondary memory 818 may include a non-transitory machine-readable storage medium (or more specifically a non-transitory machine-accessible storage medium) 831 on which is stored one or more sets of instructions (e.g., the software 822) embodying any one or more of the methodologies or functions described herein. The software 822 may also reside, or alternatively reside within the main memory 804, and may further reside completely or at least partially within the processor 802 during execution thereof by the machine 800, the main memory 804, and the processor 802 also constituting machine-readable storage media. The software 822 may further be transmitted or received over a network 820 via the network interface card 808.

In the foregoing description, numerous specific details are set forth such as examples of specific systems, languages, components, etc., in order to provide a thorough understanding of the various embodiments. It will be apparent, however, to one skilled in the art that these specific details need not be employed to practice the embodiments disclosed herein. In other instances, well-known materials or methods have not been described in detail in order to avoid unnecessarily obscuring the disclosed embodiments.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software.

Embodiments also relate to an apparatus for performing the operations disclosed herein. This apparatus may be specially constructed for the required purposes, or it may be a general-purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear as set forth in the description below. In addition, embodiments are not described with reference to any particular programming language. It will be appreciated that a variety of programming languages may be used to implement the teachings of the embodiments as described herein.

Embodiments may be provided as a computer program product, or software, that may include a non-transitory machine-readable medium having instructions stored thereon, which may be used to program a computer system (or other electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., ROM, RAM, magnetic disk storage media, optical storage media, flash memory devices, etc.), a machine (e.g., computer) readable transmission medium (electrical, optical, acoustical), etc.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems where are not directly discussed.

According to another embodiment, there are provided systems and methods for implementing Industry Based Language Translation, including processing based on a given use of terminology, context based terms, or user experience data and context.

The methods and systems disclosed herein accommodate the needs of the widest possible number of industries that utilize or have a need for business management software by providing wide variety of customizable tools and options for operating virtually any type of business or entity. Thus, business subscribers have a highly customizable solution available to them for facilitating transactions between themselves and their consumers through a cloud-based system without having to conform to restrictive industrial specific applications or turn to developing their own non-cloud service solution at great expense and complexity.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims should be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

1-43. (canceled)

44. A method, comprising:
receiving a request from a client for available services and service providers;
displaying search results to the client, wherein the search results include the available services
receiving a first selection by the client for a first service of the available services;
adding the first service to a service cart pending checkout;
receiving a second selection by the client for a second service of the available services;
adding the second service to the service cart pending checkout; and
displaying a service checkout interface to the client, wherein the service checkout interface includes the service cart having the first service and second service.

45. The method of claim 44, wherein the first service is provided by a first entity and the second service is provided by a second entity.

46. The method of claim 44, further comprising:
receiving a second request by the client for products;
in response to the second request, triggering a product recommendation; and
displaying product results to the client, wherein the product results include one or more available products.

47. The method of claim 46, further comprising;
receiving a product selection from the client; and
adding one or more selected products to the service cart substantially simultaneously with the first service and the second service.

48. The method of claim 47, wherein the available products include one or more of:
a product available from a service provider for the first or second services;
a product available within an inventory of a service provider; and
a product available from a provider that is different from a service provider for the first or second services.

49. The method of claim 44, further comprising recommending products available for purchase substantially simultaneously with the search results,
wherein one or more of:
the products are available from a selected service provider for pickup or for use at a location of the selected service provider at a time in which the service is scheduled;
the products are available from a third party different from a selected service provider;
the products include one or more generally available products at a first entity for use with multiple service providers associated with a second entity; and
the products are available for shipment and arrival at a location specified by a client prior to a service scheduled with a service provider.

50. The method of claim 49, wherein the products are selected according to one or more of:
paid advertising;
products that are capable of use during the service selected;
products available from the service provider selected; and
products identified responsive to search parameters specified by the client prior to final payment for the services selected.

51. The method of claim 44, further comprising:
displaying a time and date selection interface to the client;
receiving a time and date selection from the client via the time and date selection interface for one or more of the first service and the second service;
displaying to the client one or more service providers that are available to perform the first service and the second service; and
receiving a desired provider selection by the client for the first service.

52. The method of claim 51, further comprising:
displaying a calendar interface;
receiving a date and time selection for one or more of the first service and the second service;
adding a calendar appointment for one or more of the first service and the second service to both a provider calendar for a service provider at which the service is booked; and
contemporaneously adding the calendar appointment to a client calendar.

53. The method of claim 44, further comprising receiving search parameters from the client for available services and for service providers, wherein the search parameters include:
a geographic constraint determined on behalf of the client or based on explicit search parameters provided by the client; and
a time constraint determined on behalf of the client or based on explicit search parameters provided by the client.

54. A non-transitory computer-readable storage medium having instructions stored thereon that, when executed by one or more processors cause performance or control performance of operations comprising:
receiving a request from a client for available services and service providers;
displaying search results to the client, wherein the search results include the available services
receiving a first selection by the client for a first service of the available services;
adding the first service to a service cart pending checkout;
receiving a second selection by the client for a second service of the available services;
adding the second service to the service cart pending checkout; and
displaying a service checkout interface to the client, wherein the service checkout interface includes the service cart having the first service and second service.

55. The non-transitory computer-readable storage medium of claim 54, wherein the first service is provided by a first entity and the second service is provided by a second entity.

56. The non-transitory computer-readable storage medium of claim 54, wherein the operations further comprise:
receiving a second request by the client for products;
in response to the second request, triggering a product recommendation; and
displaying product results to the client, wherein the product results include one or more available products.

57. The non-transitory computer-readable storage medium of claim 56, wherein the operations further comprise:
receiving a product selection from the client; and
adding one or more selected products to the service cart substantially simultaneously with the first service and the second service.

58. The non-transitory computer-readable storage medium of claim 57, wherein the available products include one or more of:
a product available from a service provider for the first or second services;
a product available within an inventory of a service provider; and
a product available from a provider that is different from a service provider for the first or second services.

59. The non-transitory computer-readable storage medium of claim 54, wherein:
the operations further comprise recommending products available for purchase substantially simultaneously with the search results; and
one or more of:
the products are available from a selected service provider for pickup or for use at a location of the selected service provider at a time in which the service is scheduled;
the products are available from a third party different from a selected service provider;
the products include one or more generally available products at a first entity for use with multiple service providers associated with a second entity; and
the products are available for shipment and arrival at a location specified by a client prior to a service scheduled with a service provider.

60. The non-transitory computer-readable storage medium of claim 59, wherein the products are selected according to one or more of:
paid advertising;
products that are capable of use during the service selected;
products available from the service provider selected; and
products identified responsive to search parameters specified by the client prior to final payment for the services selected.

61. The non-transitory computer-readable storage medium of claim 54, wherein the operations further comprise:
displaying a time and date selection interface to the client;
receiving a time and date selection from the client via the time and date selection interface for one or more of the first service and the second service;
displaying to the client one or more service providers that are available to perform the first service and the second service; and
receiving a desired provider selection by the client for the first service.

62. The non-transitory computer-readable storage medium of claim 61, wherein the operations further comprise:
displaying a calendar interface;
receiving a date and time selection for one or more of the first service and the second service;
adding a calendar appointment for one or more of the first service and the second service to both a provider calendar for a service provider at which the service is booked; and
contemporaneously adding the calendar appointment to a client calendar.

63. The non-transitory computer-readable storage medium of claim 54, wherein:
the operations further comprise receiving search parameters from the client for available services and for service providers; and
the search parameters include a geographic constraint determined on behalf of the client or based on explicit search parameters provided by the client, and a time constraint determined on behalf of the client or based on explicit search parameters provided by the client.
